(19) United States
(12) Patent Application Publication
(10) Pub. No.: US 2025/0207437 A1
(43) Pub. Date: Jun. 26, 2025

(54) RESTRAINT DEVICE

(71) Applicant: HIGH SECURITY CUFFS LLC, Great Neck, NY (US)

(72) Inventors: Moshe HOROVITZ, Woodland Hills, CA (US); Jacob KRAVEL, Great Neck, NY (US); Mordechay SHECHTER, Bethesda, MD (US)

(21) Appl. No.: 18/850,078

(22) PCT Filed: Mar. 23, 2023
(86) PCT No.: PCT/IB2023/052876

§ 371 Date: Sep. 24, 2024

Related U.S. Application Data
(60) Provisional application No. 63/323,099, filed on Mar. 24, 2022.

(51) Int. Cl. E05B 75/00

(52) U.S. Cl. CPC E05B 75/00

(57) ABSTRACT

The present invention relates to a restraint device. More specifically, the present invention relates to restraint devices such as thumb cuffs, handcuffs and leg-cuffs including a restraint device for readily restraining an individual including a first single strand, a second single strand hingedly attached to the first single strand and a first locking mechanism requiring a key to open the locking mechanism for readily preventing the strand from being opened, once closed around a person's thumb, wrist or ankle, and for readily preventing a cuffed person from moving his or her thumbs, wrists or feet more than a few centimeters or inches apart, making many tasks difficult or impossible.

### FIELD AND BACKGROUND OF THE INVENTION

The present invention relates to a restraint device. More specifically, the present invention relates to restraint devices such as thumb cuffs, handcuffs and leg-cuffs including at least one lockable rotating arm for readily preventing the arm from being opened once closed around a person's thumb, wrist or ankle, and for readily preventing a cuffed person from moving his or her thumbs, wrists or feet more than a few centimeters or inches apart, making many tasks difficult or impossible.

Since the advent of handcuffs as a restraint device, the use of handcuffs has been met with a wide range of difficulties arising from latent deficiencies of handcuffs known in the art.

Handcuffs known in the art are only intended as temporary restraints, and invariably do not include complicated locks. This latent deficiency is why escaping from handcuffs is a common stunt performed by magicians or skilled criminals, perhaps most famously by the late Harry Houdini.

There are several known ways of escaping from handcuffs, including: slipping your hands out when the hands are smaller than the wrist, lock picking, releasing the pawl with a shim and opening the handcuffs with a duplicate key, often hidden on the body of the individual retained by the handcuffs.

One of the ways known in the art to address the first method was the addition of a ratchet mechanism to handcuffs, which can be adjusted to a variety of sizes. Modern handcuffs are generally ratcheted until they are too tight to be slipped off the hands. However, slipping out of ratchet cuffs is still possible. During his shows, Harry Houdini was frequently secured with multiple pairs of handcuffs. Any pair that was too difficult to be picked was placed on his upper arms. Being very muscular, his upper arms were far larger than his hands. Once he had picked the locks on the lower pairs of handcuffs, the upper pair could simply be slipped off.

Another methodology known in the art to remove handcuffs is by applying massive amounts of force from one's arms to cause the device to split apart or loosen enough to squeeze one's hands through. Nevertheless, this technique is seldom used as it requires exceptional strength (especially with handcuffs made of steel). This also puts an immense amount of pressure on the biceps and triceps muscles, and when tried by suspects (even unsuccessfully) can lead to injury, including bruising around the wrists, or tearing the muscles used (including pulling them off their attachments to the bones).

Another methodology known in the art when attempting to remove handcuffs, when the individual is handcuffed behind the back, is that one would, from a sitting or lying position, bring one's legs up as high upon one's torso as possible, then push one's arms down to bring the handcuffs below one's feet, finally pulling the handcuffs up using one's arms to the front of one's body. This can lead to awkward or painful positions depending on how the handcuffs are applied, typically requiring a good amount of flexibility. It can also be done from a standing position, where, with some degree of effort, the handcuffed hands are slid around the hips and down the buttocks to the feet; then sliding each foot up and over the cuffs. These maneuvers, and the reverse (otherwise impossible) maneuver of bringing the handcuffed hands up behind the back and forwards over the head and then down in front, can be readily performed by some people who were born without collarbones because of the inherited deformity called cleidocranial dysostosis. From this position, one has a better chance of attempting to use a tool (such as a shim or lock pick) to work one's way out of the handcuffs.

There are many types of handcuffs which are usually differentiated by the methodology of linking the two parts of the handcuffs such as by a chain, a hinge, or rigid bar.

The chain handcuff is the most popular type of handcuff on the market today used by a wide array of consumers; personal, military, corrections officers, police officers and security guards.

The chain handcuff invariably comprises two halves linked by a chain approximately 2″ (2 inches) in length keeping the restrained persons wrist close together helping the restrainer control them. Each cuff has a rotating side that ratchets into the stationary side. With the cuff open you place the wrist in the middle and close the rotating side into the stationary side, thus locking the cuff. The cuff will not back out without the key and when both wrists are cuffed, the person has limited movement.

Known disadvantages of chained handcuffs known in the art include: the chain allows for more movement than other types of hand restraints, without a double lock, it allows the cuff to over tighten, in some cases creating too much force, if not properly applied the cuff can be defeated, poor control of individuals and if an unskilled officer has his hand or any digits on the chain, the cuffed individual can cross his hands and “catch” the officer's hand or digits, thereby potentially severely injuring the officer.

Hinged handcuffed are also well known in the art. Corrections officers invariably prefer these cuffs over the chain type because it gives them better control over the inmate. Hinged handcuffed operate similarly to the chained handcuffs but are connected by a hinge making them more ridged. Unlike chained handcuffs, where the hands and wrists have some movement, the hinge doesn't allow the wrists to move together or apart at all.

Nevertheless, both chained and hinged handcuffs suffer from latent deficiencies of not including complicated locks and are susceptible of being removed without a key.

A further latent deficiency of handcuffs known in the art is that the same key can operated and open a majority of handcuffs and thus, a single key readily obtainable and concealed and remove almost all handcuffs known in the art.

Yet a further latent deficiency of handcuffs known in the art is the use of a single strand (arm) hingedly attached to a double strand with a gap formed in between the double strand to readily accommodate the single strand when the single strand is displaced about the hinge. Often, individuals wishing to escape or break the handcuffs known in the art, will apply insert an object or the single strand of another cuff thereby leveraging the handcuff mechanism out of alignment, resulting in opening the handcuffs or fracturing at least one of the strands, resulting in the escape of the individual from the handcuffs.

Furthermore, failing to double lock handcuffs known in the art can result in too much force being applied to the wrists and the cuffs can be successfully removed if they are not applied properly.

A further latent deficiency of handcuffs known in the art is that their construction in invariably metallic owing to the need for enhanced strength. A drawback of such a construction is a weight of at least 16 oz. (450 grams) for a single pair of handcuffs, wherein officers have been known to carry two pairs of handcuffs are faced with a heavy load to carry throughout their day.

An attempt to overcome the deficiencies of handcuffs known in the art, when facing the need to restrain multiple individuals in a short period are the plastic cuffs is also known as “zip ties”.

The plastic cuffs known as “zip ties” usually come in the form of a single cable tie around both wrists or with a pair of interlocking straps. Although “zip tie” plastic cuffs are lighter and cheaper than regular handcuffs, they suffer from a latent deficiency of being “one-time use” cuffs as well as possibility of overtightening the plastic cuffs and causing injury. Furthermore, use of “zip tie” plastic cuffs entails a higher risk of escape by brute force, melting by way of direct or indirect heat, or simply cutting them.

Further still, “zip tie” plastic cuffs cannot be loosened, and must be cut off to permit a restrained subject to be fingerprinted, or to attend to bodily functions. It is not unheard of for a single subject to receive five or more sets of plastic cuffs in his or her first few hours in custody.

Therefore, there is an unmet need for, and it would be highly useful to have, a reliable, lightweight, and secure restraint device for readily preventing lock picking, releasing the pawl with a shim, use of brute force and opening the handcuffs with a duplicate key and including at least two single strands.

### SUMMARY OF THE INVENTION

The present invention is a reliable, lightweight, and secure restraint device for readily preventing lock picking, releasing the pawl with a shim, use of brute force.

According to the present invention, there is provided a restraint device for readily restraining an individual including a first single strand, a second single strand hingedly attached to the first single strand and a first locking mechanism requiring a key to open the locking mechanism.

According to further embodiments of the present invention, there is provided a method for restraining an individual, the method includes the steps of: providing a restraint device for readily restraining an individual including a first single strand, a second single strand hingedly attached to the first single strand and a first locking mechanism requiring a key to open the locking mechanism.

### BRIEF DESCRIPTION OF THE DRAWINGS

The invention is herein described, by way of example only, with reference to the accompanying drawings, wherein:

FIG. 1. is a perspective view of an exemplary embodiment of the restraint device for readily restraining an individual of the present invention;

FIG. 2. is a cross sectional view of an exemplary embodiment of the restraint device for readily restraining an individual of the present invention;

FIG. 3. is a cross sectional view of an exemplary embodiment of the restraint device for readily restraining an individual, especially above the malleolus and or securing the tibia of the present invention; and

FIG. 4 is a perspective view of an exemplary embodiment of testing equipment for readily testing torque resilience according to the present invention.

### DESCRIPTION OF THE PREFERRED EMBODIMENTS

The present invention is a reliable, lightweight, and secure restraint device for readily preventing lock picking, releasing the pawl with a shim, use of brute force and opening the handcuffs and including at least two single strands.

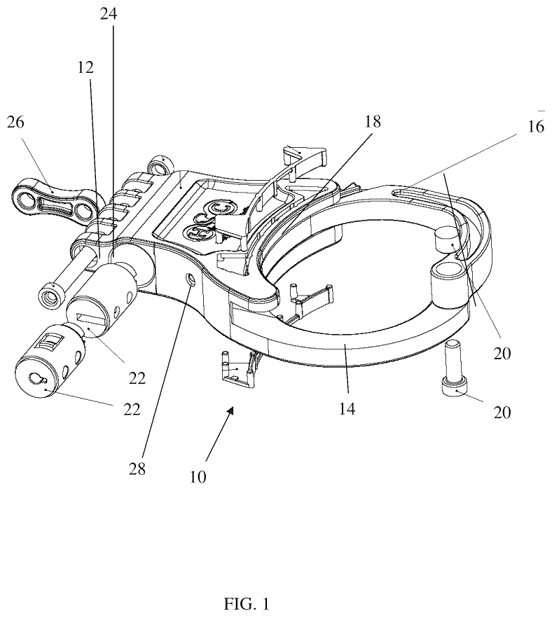

Referring now to the drawings, FIG. 1 shows a perspective view of a first embodiment of a restraint device 10 for readily restraining an individual. As shown in FIG. 1, a body 12 includes a first single strand 14 attached to or integrally formed with body 12.

Preferably, first single strand 14 is attached to a second single strand 16.

Preferably, second single strand 16 includes a toothed portion 18.

Preferably, first single strand 14 is attached to a second single strand 16 by way of a hinge 20 wherein single strand 14 is rotateably displaceable about hinge 20.

Preferably, body 12 includes a locking mechanism 22 wherein locking mechanism 22 is preferably a high security locking mechanism.

Preferably, locking mechanism 22 readily facilitates assigning a multiplicity of levels of access locking mechanism 22.

Preferably, locking mechanism 22 readily facilitates accessing each restraint device 10 with a different key.

Optionally, locking mechanism 22 readily facilitates accessing each restraint device 10 with a supervisor key readily facilitating accessing multiple restraint devices 10 with a single key.

Optionally, locking mechanism 22 readily facilitates access to multiple restraint devices 10 a single high security key, rendering common handcuff keys useless.

Preferably, restraint device 10 includes at least one coupling interface 24 for readily attaching at least two restraint devices 10 to each other.

As shown in FIG. 1, coupling interface 24 includes at least one coupling link 26 for readily coupling at least two restraint devices 10 to each other.

Preferably, at least three components selected from the group consisting of: first single strand 14, second single strand 16, toothed portion 18, hinge 20, locking mechanism 22, coupling interface 24 and coupling link 26 are substantially constructed from a polymer.

Preferably, at least three components selected from the group consisting of: first single strand 14, second single strand 16, toothed portion 18, hinge 20, locking mechanism 22, coupling interface 24 and coupling link 26 are non-metallic.

Preferably, locking mechanism 22 is a “double lock” mechanism.

A “double lock” detent 28 is provided to readily facilitate stopping the wearer from tightening restraint device 10 intentionally or by struggling.

Preferably, at least 60% by weight of restraint device 10 is substantially constructed from a polymer. Preferably, at least 60% by weight of restraint device 10 is substantially non-metallic.

Preferably, substantially 100% of restraint device 10 is constructed from a polymer. Preferably, substantially 100% of restraint device 10 is constructed of non-metallic materials.

Preferably, restraint device 10 complies with Criminal Justice Restraints NIJ Standard 1001.00.

Preferably, restraint device 10 qualifies as a “Type 3” restraint under Criminal Justice Restraints NIJ Standard 1001.00.

Restraint device 10 is intended for control when a subject is not under direct observation but is supervised continuously, such as during transport. Restraint device 10 is intended to be reusable for thousands of uses and have a keyed locking mechanism operated by a standard key.

Preferably, Restraint device 10 has a higher level of tamper resistance than Type 2.

Optionally, restraint device 10 qualifies as a “Type 4” restraint under Criminal Justice Restraints NIJ Standard 1001.00.

Preferably, restraint device 10 has a higher level of tamper resistance than Type 3.

Preferably, restraint device 10 readily facilitates each and every restraint device 10 to be subjected to a Standard Key Functionality Test (Section 6.16 Criminal Justice Restraints NIJ Standard 1001.00). A standard key(s) supplied with restraint device 10 shall successfully release the locking mechanism 22 with every attempt.

Preferably, restraint device 10 readily passes Decontamination Solution Exposure Conditioning, and Section 6.12 Criminal Justice Restraints NIJ Standard 1001.00, Type 3 and Type 4 Restraints Operational Tests.

Preferably, restraint device 10 readily passes Salt Spray Exposure Conditioning after Decontamination Solution Exposure Conditioning.

Preferably, restraint device 10 readily passes Type 3 and Type 4 Restraints Static Load Test (Section 6.9 Criminal Justice Restraints NIJ Standard 1001.00).

Preferably, restraint device 10 readily passes a Temperature Exposure Conditioning, as specified in Section 6.3.2 Criminal Justice Restraints NIJ Standard 1001.00, as well as restraint device 10 remaining functional and demonstrate no unintentional release of restraint device 10.

Preferably, restraint device 10 readily passes a Dynamic Load Test, remaining functional and demonstrate no unintentional release of restraint device 10.

Preferably, restraint device 10 readily passes Type 3 and Type 4 Restraints Cheek Plate Test (Section 6.9 Criminal Justice Restraints NIJ Standard 1001.00) without demonstrating an unintentional release of restraint device 10.

Preferably, occasioning on locking mechanism 28 being a “double lock”, restraint device 10 readily passes Type 3 and Type 4 Restraints Double-Lock Impact Test (Section 6.14 Criminal Justice Restraints NIJ Standard 1001.00) without demonstrating an unintentional release of restraint device 10.

Preferably, restraint device 10 readily passes Type 3 and Type 4 Restraints Compression Test (Section 6.15 Criminal Justice Restraints NIJ Standard 1001.00) without demonstrating a deformation or an unintentional release of restraint device 10.

Preferably, restraint device 10 readily facilitates substantially no displacement of ratchet to a next position under a 50-lb load is achieved.

Preferably, restraint device 10 readily passes Type 3 and Type 4 Restraints Twist Test followed by a Section 6.12 Criminal Justice Restraints NIJ Standard 1001.00, Type 3 and Type 4 Restraints Operational Tests.

Preferably, restraint device 10 readily passes Flame Exposure Resistance Test (Section 6.8 Criminal Justice Restraints NIJ Standard 1001.00) wherein is self-extinguishing.

Preferably, restraint device 10 readily passes a Nonstandard Key Functionality Test according to section 6.17 Criminal Justice Restraints NIJ Standard 1001.00 wherein nonstandard key 21 (not shown in FIG. 1) supplied with each sample shall successfully releases locking mechanism 28 with every attempt.

Optionally, standard keys shall not successfully release the locking mechanism 28 for enhanced security properties.

Preferably, at least three components selected from the group consisting of: first single strand 14, second single strand 16, toothed portion 18, hinge 20, locking mechanism 22, coupling interface 24 and coupling link 26 are substantially constructed of fiberglass.

Preferably, at least three components selected from the group consisting of: first single strand 14, second single strand 16, toothed portion 18, hinge 20, locking mechanism 22, coupling interface 24 and coupling link 26 are fiberglass reinforced.

Preferably, at least three components selected from the group consisting of: first single strand 14, second single strand 16, toothed portion 18, hinge 20, locking mechanism 22, coupling interface 24 and coupling link 26 are substantially constructed of carbon fiber.

Preferably, at least three components selected from the group consisting of: first single strand 14, second single strand 16, toothed portion 18, hinge 20, locking mechanism 22, coupling interface 24 and coupling link 26 are carbon fiber reinforced.

The term “Cuff” as used herein, shall include but will not be limited to a restraint device designed to secure an individual's wrists in proximity to each other after being arrested or detained by police and/or security forces, a restraint device designed to secure an individual's feet in proximity to each other after being arrested or detained by police and/or security forces, a restraint device designed to secure an individual's hand or thumbs in proximity to each other after being arrested or detained by police and/or security forces, a restraint device comprising two parts, linked together by a chain, a hinge, or rigid bar, a restraint device with at least one rotating arm which engages with a ratchet preventing the arm from being opened once closed around a person's thumb, wrist or ankle, a restraint device requiring a key to be removed, and a restraint device for preventing a handcuffed person from moving his or her thumbs, wrists or feet more than a few centimeters or inches apart, making many tasks difficult or impossible and a restraint device frequently used worldwide for preventing suspected criminals from escaping from custody.

The term “Double lock” as used herein, shall include but will not be limited to handcuffs with a detent which, when engaged, stops the cuff from ratcheting tighter to prevent the wearer from tightening them either intentionally or by struggling, handcuffs with a detent for locking the handcuffs and readily preventing wearers from tightening the cuffs to attempt an escape by having the officer loosen the cuffs and attempting to escape while the cuffs are loose, an internal securing mechanism within handcuffs for readily making picking the locks more difficult.

The term “Pawl” as used herein, shall include but will not be limited to a mechanical handcuff component that engages with another component to prevent displacement in at least one direction, or preferably preventing inadvertent displacement altogether, a type of latch in a handcuff mechanism including a spring-loaded solid part readily pivotable at a first extremity and readily engaging an additional component at a substantially steep angle at a second extremity, a mechanical handcuff component that engages with another component in combination with a ratchet thereby readily preventing inadvertent displacement of the handcuff arm.

The term “Polymer” as used herein, shall include but will not be limited to a substance or material consisting of either organic or non-organic, very large molecules, or macromolecules, composed of many repeating subunits, a synthetic or semi-synthetic material constructed with very large molecules, or macromolecules, composed of many repeating subunits as a main ingredient, a material formed from chains of carbon atoms, with or without the attachment of oxygen, nitrogen or sulfur atoms, including many repeating units formed from monomers, a material including side chain molecular groups hung from the monomers wherein the structure of these side chains influences the properties of the polymer, a high strength, abrasion and impact resistant thermoplastic polyamide formulations of the family more commonly known as nylon, a high strength, abrasion and impact resistant thermoplastic polyamide formulations selected from the group consisting of Nylon 6, nylon 66 and nylon 610, and a resin based on polyphthalamides reinforced with fiberglass.

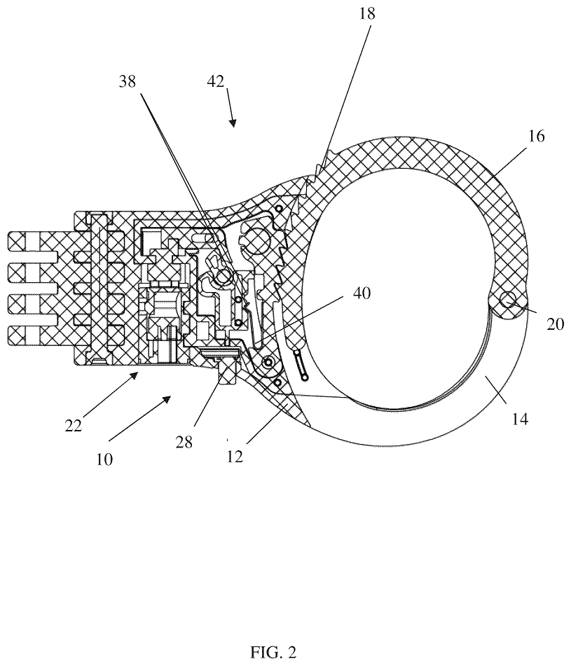

FIG. 2 shows a cross section view of a second embodiment of a restraint device 10 for readily restraining an individual. As shown in FIG. 2, a body 12 includes a first single strand 14 attached to or integrally formed with body 12.

Preferably, first single strand 14 is attached to a second single strand 16.

Preferably, first single strand 14 is substantially constructed from a polymer.

Preferably, first single strand 14 is substantially non-metallic.

Preferably, first single strand 14 is attached to a second single strand 16 by way of a hinge 20 wherein single strand 14 is rotateably displaceable about hinge 20.

Preferably, second single strand 16 is substantially constructed from a polymer. Preferably, second single strand 16 is substantially non-metallic

A “double lock” detent 28 is provided to readily facilitate stopping the wearer from tightening restraint device 10 intentionally or by struggling.

Preferably, second single strand 16 includes a toothed portion 18.

Preferably, toothed portion 18 engages a pawl 42.

Preferably, pawl 42 readily engages toothed portion 18 of second single strand 16 thereby “locking” restraint device 10.

Preferably, pawl 42 prevents inadvertent displacement of first single strand 14 and/or second single strand 16 in at least one direction, or preferably preventing inadvertent displacement of first single strand 14 and/or second single strand 16.

Preferably, pawl 42 is readily locked by a protruded member 38.

More preferably, protruded member 38 readily prevents pawl 42 from being displaced and thus readily prevents inadvertent displacement of first single strand 14 and/or second single strand 16 in at least one direction.

Preferably, protruded member 38 is activated or engaged by way of “double lock” detent 28.

For the purpose of inadvertent or malicious displacement of protruded member 38, a split leaf spring 40 is attached to or integrally formed with body 12 and applies a counter pressure against disengaging protruded member 38 and pawl 42.

Preferably, body 12 includes a locking mechanism 22 wherein locking mechanism 22 is preferably a high security locking mechanism.

Preferably, locking mechanism 22 readily facilitates assigning a multiplicity of levels of access locking mechanism 22.

Preferably, locking mechanism 22 readily facilitates accessing each restraint device with a different key or a “Nonstandard” key 21 (not shown in FIG. 1) according to Criminal Justice Restraints NIJ Standard 1001.00.

Optionally, locking mechanism 22 readily facilitates accessing each restraint device 10 with a supervisor key readily facilitating accessing multiple restraint devices 10 with a single key.

Optionally, locking mechanism 22 readily facilitates access to multiple restraint devices 10 a single high security key, rendering common handcuff keys useless.

It is envisaged that some prisoners being transported from custody to outside locations, for appearances at court, to medical facilities will wear restraint device 10 as handcuffs.

It is further envisaged that some prisoners being transported from custody to outside locations, for appearances at court, to medical facilities will wear restraint device 10 augmented with a belly chain. Preferably, a metal, leather, or canvas belt is locked on to the waist of the individual.

Restraint device 10 is preferably secured to a belly chain for readily facilitating positioning prisoner's hands substantially at waist level, thereby providing a degree of comfort during prolonged internment with restraint device 10, while providing a greater degree of restriction to movement than simply placing restraint device 10 on the wrists of the individual in the front.

For added security, transport of individuals is facilitated by restraint device 10 used as handcuffs being augmented by leg-cuffs with a belly chain and a long connector chain.

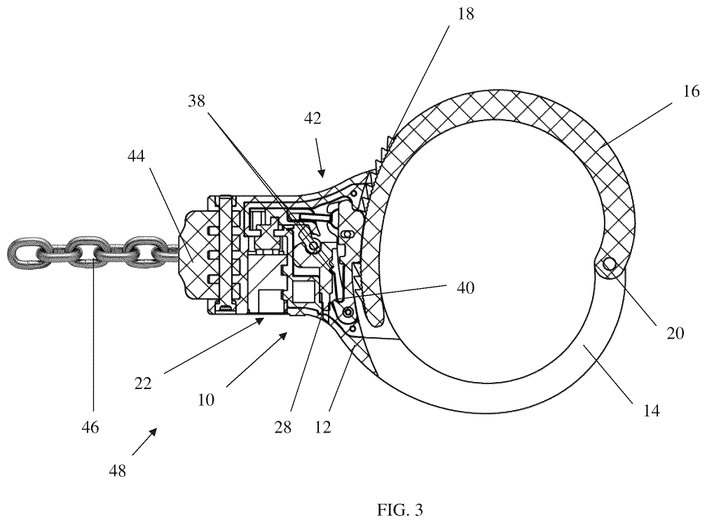

FIG. 3 shows a cross section view of a second embodiment of a restraint device 10 for readily restraining an individual by way of encircling the tibia bone. As shown in FIG. 3, a body 12 includes a first single strand 14 attached to or integrally formed with body 12.

Preferably, first single strand 14 is attached to a second single strand 16.

Preferably, first single strand 14 is substantially constructed from a polymer. Preferably, first single strand 14 is substantially non-metallic.

Preferably, first single strand 14 is attached to a second single strand 16 by way of a hinge 20 wherein single strand 14 is rotateably displaceable about hinge 20.

Preferably, second single strand 16 is substantially constructed from a polymer. Preferably, second single strand 16 is substantially non-metallic

A “double lock” detent 28 is provided to readily facilitate stopping the wearer from tightening restraint device 10 intentionally or by struggling.

Preferably, second single strand 16 includes a toothed portion 18.

Preferably, toothed portion 18 engages a pawl 42.

Preferably, pawl 42 readily engages toothed portion 18 of second single strand 16 thereby “locking” restraint device 10.

Preferably, pawl 42 prevents inadvertent displacement of first single strand 14 and/or second single strand 16 in at least one direction, or preferably preventing inadvertent displacement of first single strand 14 and/or second single strand 16.

Preferably, pawl 42 is readily locked by a protruded member 38.

More preferably, protruded member 38 readily prevents pawl 42 from being displaced and thus readily prevents inadvertent displacement of first single strand 14 and/or second single strand 16 in at least one direction.

Preferably, protruded member 38 is activated or engaged by way of “double lock” detent 28.

For the purpose of inadvertent or malicious displacement of protruded member 38, a split leaf spring 40 is attached to or integrally formed with body 12 and applies a counter pressure against disengaging protruded member 38 and pawl 42.

Preferably, body 12 is attached to, or integrally formed with a coupling link 44 for readily interconnecting at least two restraining devices 10 by way of a chain 46 or similarly strong interconnecting media.

Preferably, each pair of interconnected restraint devices 10 are readily useable as a “Leg cuff” 48. Namely, leg cuff 48 readily provides a physical restraints used on the ankles of a person to allow walking only with a restricted stride and to prevent running and effective physical resistance.

Preferably, leg cuff 48 readily facilitates restraining an individual, especially above the malleolus and or securing the tibia of the individual.

The term “Leg cuffs” as used herein shall include but will not be limited to leg/ankle shackles, foot cuffs, fetters or leg irons. Shackles have been commonly used on prisoners and slaves. Leg shackles have also been used for chain gangs to keep them together.

Preferably, chain 46 is substantially 400 mm in length for readily facilitating enhanced restraining properties, as in comparison to handcuffs, wherein the wearing of leg cuff 48 readily facilitates less restrictive restraining of individuals.

Preferably, body 12 includes a locking mechanism 22 wherein locking mechanism 22 is preferably a high security locking mechanism.

Preferably, chain 46 has a length facilitating limited movement of the person “cuffed”. Nevertheless, running or escape attempts should be substantially thwarted due to the limited movement of the individual with Leg cuffs 48.

Preferably, locking mechanism 22 readily facilitates assigning a multiplicity of levels of access locking mechanism 22.

Preferably, locking mechanism 22 readily facilitates accessing each restraint device 10 with a different key or a “Nonstandard” key 21 (not shown in FIG. 1) according to Criminal Justice Restraints NIJ Standard 1001.00.

Optionally, locking mechanism 22 readily facilitates accessing each restraint device 10 with a supervisor key readily facilitating accessing multiple restraint devices 10 with a single key.

Optionally, locking mechanism 22 readily facilitates access to multiple restraint devices 10 a single high security key, rendering common handcuff keys useless.

It is envisaged that some prisoners being transported from custody to outside locations, for appearances at court, to medical facilities will wear leg cuff 48 together or without restraint device 10 as handcuffs.

It is further envisaged that some prisoners being transported from custody to outside locations, for appearances at court, to medical facilities will wear leg cuff 48 augmented with a belly chain. Preferably, a metal, leather, or canvas belt is locked on to the waist of the individual.

Leg cuff 48 is preferably secured to a belly chain for readily facilitating positioning prisoner's hands substantially at waist level, thereby providing a degree of comfort during prolonged internment with leg cuff 48, while providing a greater degree of restriction to movement than simply placing restraint device 10 on the wrists of the individual in the front.

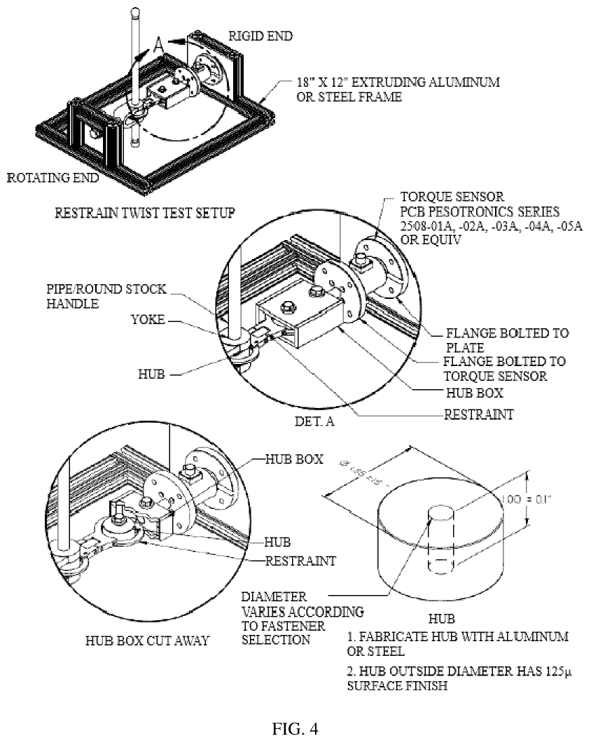

FIG. 4 shows an exemplary embodiment of testing equipment for readily testing torque resilience according to the present invention. The dimensions and configuration of the test setup shown in FIG. 4 shall be as specified herein. A first loop of is secured around at least one of a pair of drums with the locking mechanism of the restraint positioned midway between the drums. First loop (around the drum) is inserted into a hub box and secured as shown in FIG. 4. A second loop and drum is attached and secured to a rotating end of the test fixture for readily facilitating a twist displacement to occur from the center in each direction and generating a torque load.

Preferably, restraint devices 10 readily withstands a torque load of at least 50.0 N*M±2.7 N*M for at least 10 cycles or at least 20 movements

Preferably, restraint devices 10 readily withstands of a torque load of at least 67.8 N*M±2.7 N*M (50±2 ft. lbs.) for 25 cycles or 50 movements.

Preferably, each said cycle last up to 10 seconds to complete.

Preferably, restraint devices 10 for readily restraining an individual meets or exceeds a Type 4 restraint device according to Criminal Justice Restraints NIJ Standard 1001.00.

It is envisaged that the combinations of restraint device 10 and leg-cuffs further restrict the detainee's freedom of movement and readily prevent the individual from escaping. While the invention has been described with respect to a limited number of embodiments, it will be appreciated that many variations, modifications and other applications of the invention may be made.

What is claimed is:

1. A restraint device for readily restraining an individual comprising:
(a) a first single strand;
(b) a second single strand hingedly attached to said first single strand; and
(c) a first locking mechanism requiring a key to open said locking mechanism.

2. The restraint device for readily restraining an individual of claim 1, further comprising a double lock locking mechanism.

3. The restraint device for readily restraining an individual of claim 2, further comprising a ratchet mechanism for readily preventing inadvertent displacement of a mechanism selected from the group consisting of: said first strand, said second strand, said double lock and said first locking mechanism.

4. The restraint device for readily restraining an individual of claim 1 further comprising a toothed portion, a hinge attached to said first single strand and said second single strand, a locking mechanism, a coupling interface and a coupling link.

5. The restraint device for readily restraining an individual of claim 4 wherein at least three components selected from the group consisting of: said first single strand, said second single strand, said toothed portion, said hinge, said locking mechanism, said coupling interface and said coupling link are constructed of a polymer.

6. The restraint device for readily restraining an individual of claim 4 wherein said restraint device is at constructed of at least 60% Polymers by weight.

7. The restraint device for readily restraining an individual of claim 4 wherein said restraint device is at constructed of at least 100% Polymers.

8. The restraint device for readily restraining an individual of claim 4 wherein said restraint device is a Type 3 restraint device according Criminal Justice Restraints NIJ Standard 1001.00.

9. The restraint device for readily restraining an individual of claim 4 wherein said restraint device is a Type 4 restraint device according Criminal Justice Restraints NIJ Standard 1001.00.

10. A method for restraining an individual, said method comprises the steps of: a) providing the device of claim 1; b) securing said device to at least one extremity of an individual; c) placing said device within a facility; and d) activating said system or said device.

11. The method of restraining an individual according to claim 10 wherein said restraining device further comprising a toothed portion, a hinge attached to said first single strand and said second single strand, a locking mechanism, a coupling interface and a coupling link.

12. The method of restraining an individual according to claim 10 wherein said restraint device is at constructed of at least 60% Polymers by weight.

13. The method of restraining an individual according to claim 10 wherein said restraint device is at constructed of at least 100% Polymers by weight.

14. The method of restraining an individual according to claim 10 wherein said restraint device is a Type 3 restraint device according Criminal Justice Restraints NIJ Standard 1001.00.

15. The method of restraining an individual according to claim 10 wherein said restraint device is a Type 4 restraint device according Criminal Justice Restraints NIJ Standard 1001.00.

16. A restraint device for readily restraining an individual comprising:
(a) a first restraining loop hingedly attached to a second restraining loop.

17. The restraint device for readily restraining an individual of claim 16, wherein said first restraining loop includes:
(a) a first strand;
(b) a second strand hingedly attached to said first strand; and
(c) a first locking mechanism for locking said first strand.

18. The restraint device for readily restraining an individual of claim 16, wherein:
(a) said first loop and said second loop are readily securable around at least one of a pair of drums with said first locking mechanism of said restraint device is positioned midway between said drums; and
(b) wherein said first loop or said second loop situated (around said at least one of said pair of drums is inserted into a hub box and secured; and
(c) wherein said other loop and said drum are attached and secured to a rotating end of a test fixture, thereby readily facilitating a twist to occur from the center in each direction and said restraining device being readily able to withstand a torque load of at least 50.0 N*M±2.7 N*M for at least 10 cycles or at least 20 movements.

19. The restraint device for readily restraining an individual of claim 18, wherein said restraining device is readily able to withstand a torque load of at least 67.8 N*M±2.7 N*M (50±2 ft. lbs.) for at least 25 cycles or at least 50 movements.

20. The restraint device for readily restraining an individual of claim 19, wherein each said cycle last up to 10 seconds to complete.

21. The restraint device for readily restraining an individual of claim 4 wherein said restraint device meets or exceeds a Type 4 restraint device according to Criminal Justice Restraints NIJ Standard 1001.00.
